(19) United States
(12) Patent Application Publication
(10) Pub. No.: US 2006/0135003 A1
(43) Pub. Date: Jun. 22, 2006

(54) Connector with improved dual beam contacts

(75) Inventor: Kirk B. Peloza, Naperville, IL (US)

Correspondence Address: MOLEX INCORPORATED, 2222 WELLINGTON COURT, LISLE, IL, 60532, US

(73) Assignee: Molex Incorporated

(21) Appl. No.: 11/315,807

(22) Filed: Dec. 21, 2005

Related U.S. Application Data
(60) Provisional application No. 60/640,111, filed on Dec. 22, 2004.

(51) Int. Cl. H01R 13/187

(52) U.S. Cl. 439/843

(57) ABSTRACT

A mezzanine-style connector is provided with male and female engaging parts. The terminals of the female part have bifurcated contact arms and the terminals of the male part have projecting mating blades. The contact arms are cantilevered from a body portion of the female terminal and are structured so that any deflection that occurs is cantilevered, and not torsional deflection.

### REFERENCE TO RELATED APPLICATIONS

This application claims priority from prior U.S. Provisional Patent Application No. 60/640,111, filed Dec. 22, 2005.

### BACKGROUND OF THE INVENTION

The present invention relates to low insertion force male and female terminal constructions and to electrical connectors incorporating them. More particularly, it relates to a bifurcated female terminal with a pair of cantilevered contact arms that deflect when the contact portion of an opposing blade terminal is mated to the female terminal with the female terminal contact arms not incurring torsional deflection.

Various single and dual spring arm female contact electrical terminals have been provided in the past for making electrical contact with male terminals such as pins, blades, edge card contact pads and the like. Generally, in these arrangements, the male terminal must be inserted into the female with sufficient force to overcome the resistance to insertion presented by the female terminal. The insertion force of the contact structure includes a lifting component which represents the force required to lift or spread the female contact portions apart to permit passage of the male terminal into the female and also a horizontal frictional component provided as the female contact portions wipe against the male terminal during the insertion.

In multicircuit arrangements that include a large number of female terminals mounted in a connector adapted to mate with a male connector which also includes a correspondingly large number of male terminals, the individual insertion forces associated with each pair of contacts combine so that the overall insertion force required to mate the male and female connectors can be extremely large.

U.S. Pat. No. 4,740,180, issued Apr. 26, 1988 describes a low insertion force terminal assembly in which the male blade terminal includes a torsional twist and the female terminal has two contact arms that engage the blade terminal at two different contact points. The torsional twist of the male contact blade requires a complex forming procedure and increases the cost of the terminals and the assembly. Additionally, the slot that is stamped into the female terminals extends to the point of forming of the contact arms, thereby creating areas of high localized stress concentration, which may weaken the contact arms under repeated mating cycles of the connector.

Accordingly, the present invention is directed to a reliable and inexpensive low insertion force terminal assembly that may be used in high density applications, such as mezzanine connectors and which overcomes the aforementioned shortcomings.

### SUMMARY OF THE INVENTION

Accordingly, it is a general object of the present invention to provide a new and improved low insertion force mating electrical contact structure.

It is another object of the present invention to provide a reliable mating electrical contact structure including an elongated male terminal in the form of a blade and an elongated female terminal with a bifurcated contact portion, the contact portion including a pair of contact arms that extend forwardly of a terminal body portion and which are spaced apart by an intervening slot, the two contact arms each having an arcuate shape that extends along a path on opposite sides of a longitudinal centerline of the terminal body portion.

Yet another object of the present invention is to provide a blade terminal for mating with a bifurcated female terminal, the blade terminal having a longitudinal contact portion with a pair of recesses on opposing sides, which define a pair of contact surfaces that extend along longitudinal edges of the contact portion, each of the contact edges contacting a single one of the bifurcated contact arms of the opposing female terminal.

Yet a still further object of the present invention is to provide a female terminal with a pair of contact portion that take the form of elongated arms, each of the arms having an arcuate configuration, the pair of arms being separated by an intervening slot, the slot extending a first preselected distance from a free end, into a body portion of the terminal and the contact arms being formed into their arcuate configuration at a second preselected distance from the free end of the terminal so that any bends in the contact arms are spaced away from the end of the slot, thereby reducing stress which occurs during deflection of the contact arms.

Yet still another object of the present invention is to provide a terminal with bifurcated contact arms in which each of the contact arms terminates in an enlarged free end that defines a contact surface, the contact surface being formed by coining the free ends of the contact arms, the coining reducing the thickness of the contact arms at the contact surfaces.

It is a further object of the present invention to provide a new and improved low insertion force terminal structure utilizing male and female conductive terminals, the male terminals being of the blade type and the female terminals being of the bifurcated contact arm type, the female contact arms providing a means for reliably contacting the blade terminal without relying upon torsion to ensure contact between the male and female terminals.

Yet a further object of the present invention is to provide a terminal assembly for use with a mezzanine-style connector, the assembly having an insulative base extending in a given direction between two ends thereof, the base having two opposing sides which mate with the opposing ends, the base including a plurality of terminals arranged in alignment with an axis of the base, the base further having a opening along one side which exposes portions of each of the terminals to air

In accordance with the present invention, a new, low insertion force connector having improved terminals is provided and a plurality of conductive terminals are arranged in an insulative housing. One of the connectors is a male connector, while the other connector is a female connector. Both connectors have insulative housings that receive, as units, arrays of terminals. These terminal arrays include an insulative support member and the terminals are supported by the support member in a line. These arrays are received within slots formed in the connector housings.

In the male connector, the terminals include flat blade contact portions and the edges of the contact portions are rolled to a radius to define a pair of contact edges that extend longitudinally along the edges of the blade terminal. In the female connector, the terminals include flat body portions which are split by way of a longitudinal slot that extends from a free end thereof into the terminal for a preselected distance to define a pair of bifurcated contact arms.

These contact arms are formed into an arcuate configuration and extend opposite each other so that one of the contact arms extends above an axis of the body portion and the other of the contact arms extends below the axis of the body portion. The spacing slot extends into the body portion a greater distance than the length of the contact arms so that the contact arms are not formed proximate to the end of the spacing slot so as to reduce any stress concentrations that may form during use of the terminals. This also restricts the contacts arms to largely cantilevered deflection during mating rather than torsional deflection.

The contact arrays include an insulative base that extends between two opposing ends, and each of the ends including means for engaging an outer housing. A series of these bases are held within a housing to form the multi-contact aspect of the present invention. The bases have a central, hollow portion and groups of terminals are held in each bases and are aligned with a preselected axis of the base. The base's hollow portion expose one side of the terminals to air and cover the opposite sides of the group of terminals. The terminal groups may then be inserted easily into their outer housings.

These and other objects, features and advantages of the present invention will be clearly understood through a consideration of the following detailed description.

### BRIEF DESCRIPTION OF THE DRAWINGS

In the course of this detailed description, the reference will be frequently made to the attached drawings in which:

FIG. 1 is a perspective view of a connector assembly, shown as a mezzanine-style connector assembly which incorporates terminals constructed in accordance with the principles of the present invention;

FIG. 2 is the same view as FIG. 1, but with the two connectors shown in an exploded, unmated condition;

FIG. 3 is an exploded view of the female connector component of the connector assembly of FIG. 1;

FIG. 4 is a perspective view of a single terminal assembly of the female connector component of FIG. 3 showing the terminals arranged in a linear array;

FIG. 5 is a perspective view of a female terminal that is used in the connector component of FIG. 4;

FIG. 6A is a bottom plan view of the female terminal of FIG. 5, taken along lines A-A of FIG. 5;

FIG. 6B is an elevational view, taken from the mating end and along line B-B of FIG. 6A;

FIG. 6C is a side elevational view taken along lines C-C of the female terminal of FIG. 6A;

FIG. 7 is a perspective view of a single terminal assembly of the male connector component of FIG. 2 showing the male terminals arranged in a linear array;

FIG. 8 is a perspective view of a male terminal that is used in the male connector component of FIG. 2;

FIG. 9 is a cross-sectional view of the male terminal of FIG. 8, taken along lines 9-9 thereof;

FIG. 10 is a perspective view of the male and female terminals engaged together, but removed from their respective terminal support members;

FIG. 11 is a cross-sectional view taken along lines 11-11 of FIG. 10;

FIG. 12 is a side elevational view of the male and female terminals of FIG. 10;

FIG. 13 is a cross sectional view of two opposing male and female terminal assemblies, illustrating the support of the terminals therein;

FIG. 14A is a cross sectional view of a pair of a portion of FIG. 3, illustrating a pair of receptacle terminal assemblies arranged in side-by-side order; and,

FIG. 14B is a cross sectional view of a pair of a portion of FIG. 1, illustrating a pair of blade, or male terminal assemblies arranged in side-by-side order

### DETAILED DESCRIPTION OF THE PREFERRED EMBODIMENTS

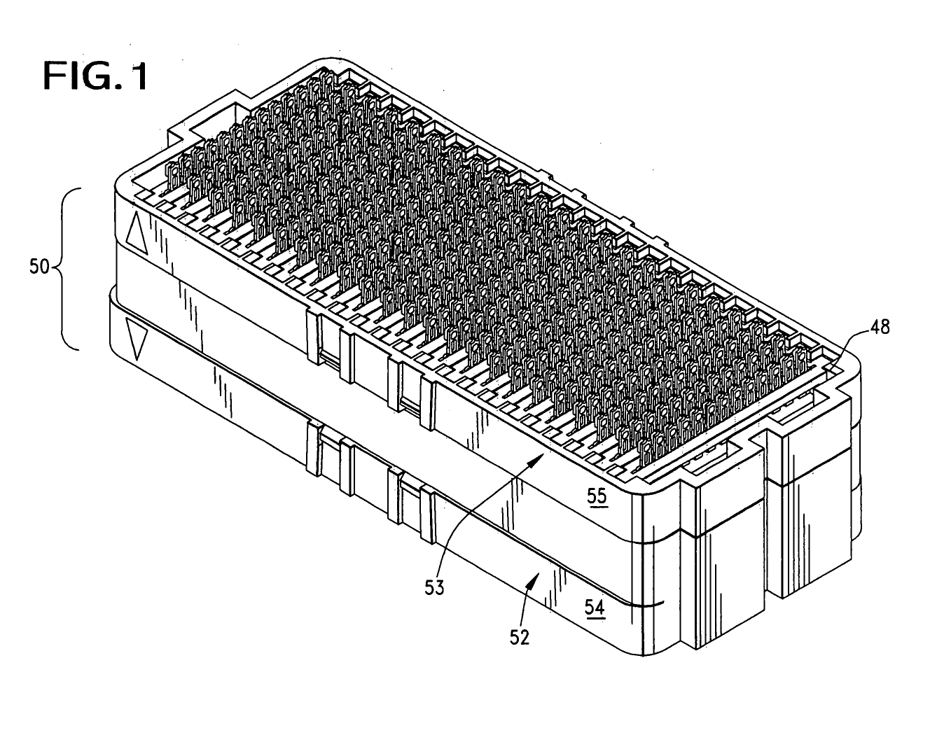

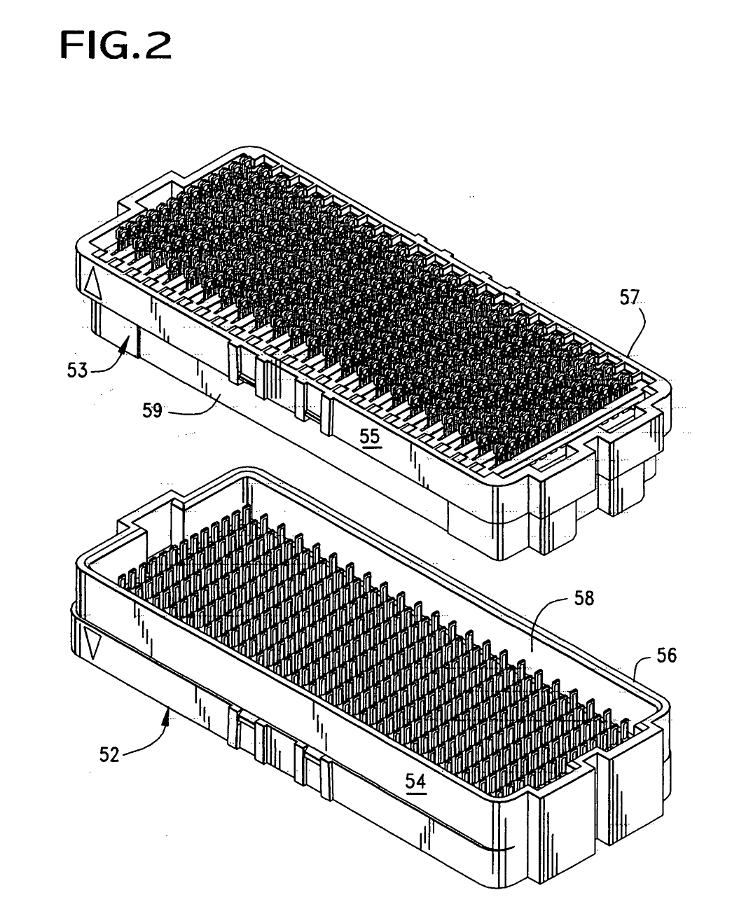

FIG. 1 illustrates a connector assembly 50 that is constructed in accordance with the principles of the present invention. The assembly 50 is comprised of two separate interengaging connector components 52, 53 (FIG. 2) that include a male connector component 52 and a female connector component 53. The terms “male” and “female” as used in this description refer to the structure of the terminals, and in this description, the male connector component 52 has a plurality of individual blade contacts that are received between arms of corresponding female terminals that are disposed in the female connector component 53.

Each connector component 52, 53 can be seen to include a plurality of conductive terminals that are supported in insulative housings 54, 55. Each such housing 54, 55 shown is seen to include an outer wall 56, 57 that defines a perimeter of the connector component and the male connector component 52 includes a hollow interior cavity 58 into which a mating portion 59 of the female connector component 53 extends.

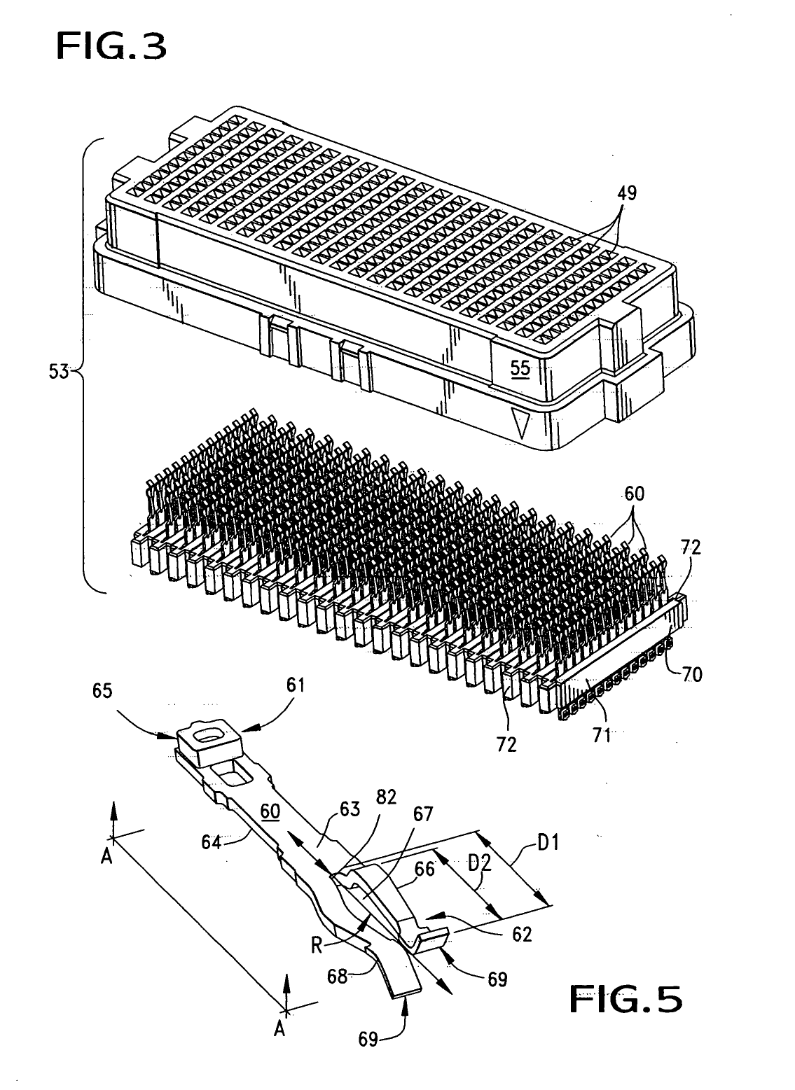

FIG. 3 illustrates the female connector component 53 in greater detail and it can be seen that the connector component 53 includes a plurality of conductive terminals 60 that are held within a plurality of terminal support members 70. The female connector component housing 55 preferably includes a plurality of terminal receiving cavities 49, each of which receives a single one of the female terminals 60. Specifically, the contact portions 62 of the female terminals 60 extend into these cavities 49.

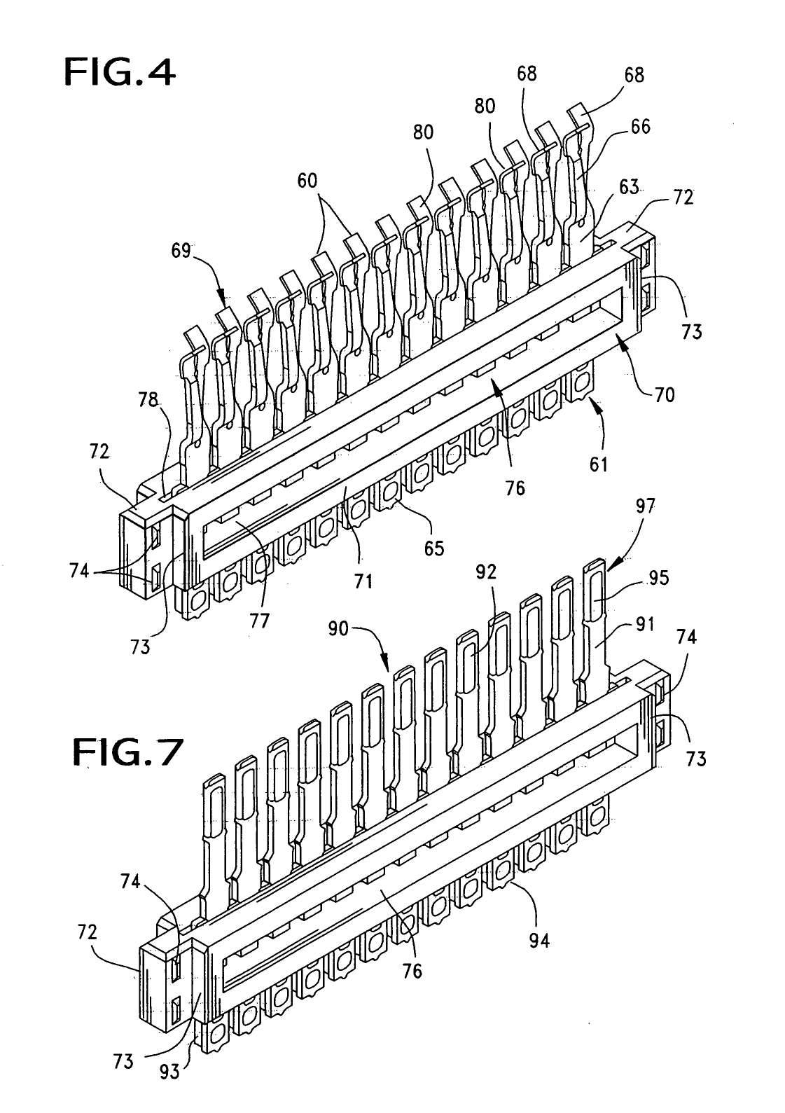

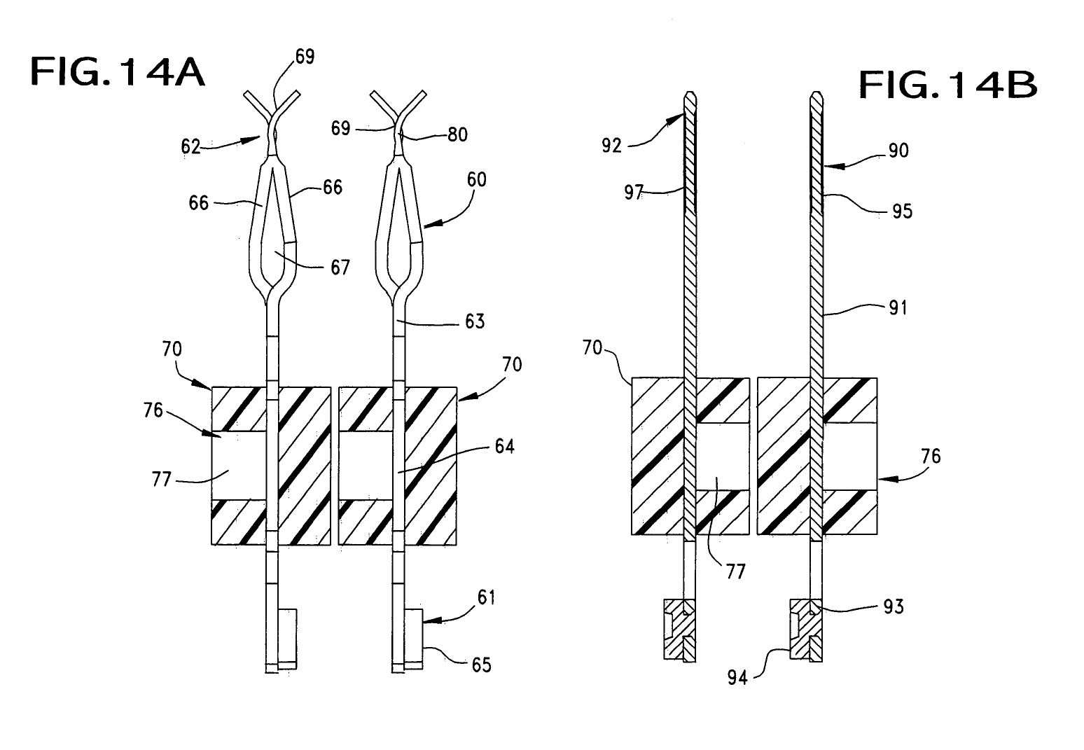

As shown in FIG. 4, the terminals are held together in a linear array with their respective connector components by a plurality of individual insulative support members 70, each of which includes a body portion 71 having a pair of engagement tabs or similar projections 72 that are disposed on the opposing end faces 73 of the body portions 71. These projections 72 are inserted into corresponding opposing slots 48 (FIG. 1) which are formed in each of the housings 54, 55. In order to provide an interference fit with the sidewalls of the connector component housing, the projections 72 may include one or more bosses 74 (FIG. 4) which are formed thereon and which will frictionally engage the connector housing slots 48 when the support members 70 are inserted. As shown in FIGS. 4 & 7, the terminal support members 70 may be hollow, and thereby include an open central portion 76 that runs widthwise between the two endfaces 73. These central portions 76 will define a series of air channels 77 between rows of terminals which are embedded in adjacent terminal support members 70. These support members 70 may be molded over the terminals 60 or the terminals 60 may be stitched into the support members through a slot 78 or they maybe preferably be molded in place within the support members 70. FIG. 14A is a cross-sectional view of a pair of the female terminal assemblies 70 arranged adjacent to each other. It can be seen that only one-half of the terminal support 70 is hollowed with its opening 77 occurring on only one side of the terminals and this structure may be considered as defining a “pocket” or air between adjacent terminal supports.

FIG. 5 illustrates a female terminal 60 that has opposing tail portions 61 and contact portions 62 that are interconnected by a body portion 63. The body portion 63 may include one or more notches 64 formed in its sides that facilitates retention of the terminal 60 in a support member 70 when an overmolding process is used to form the terminal support members 70. A soldering element 65 may be disposed on the tail portion 61 to aid in securing the terminal tail portions to opposing traces on a circuit board (not shown).

The forward, or contact portion 62 of the terminal is bifurcated, meaning that it includes a pair of spaced-apart contact arms 66 that are spaced apart from each other by an intervening slot 67. The slot 67 may be considered to run along a longitudinal axis R of the terminal and, as noted, forms two separate contact arms 66 that are intended to contact an opposing male (blade) terminal 90. The use of two contact arms 66 provides a redundant contact path for connectors using these terminals, and this redundancy not only ensures contact between the male and female terminals of the two connector components 52, 53, but it also lowers inductance of the terminals. It also reduces the insertion force.

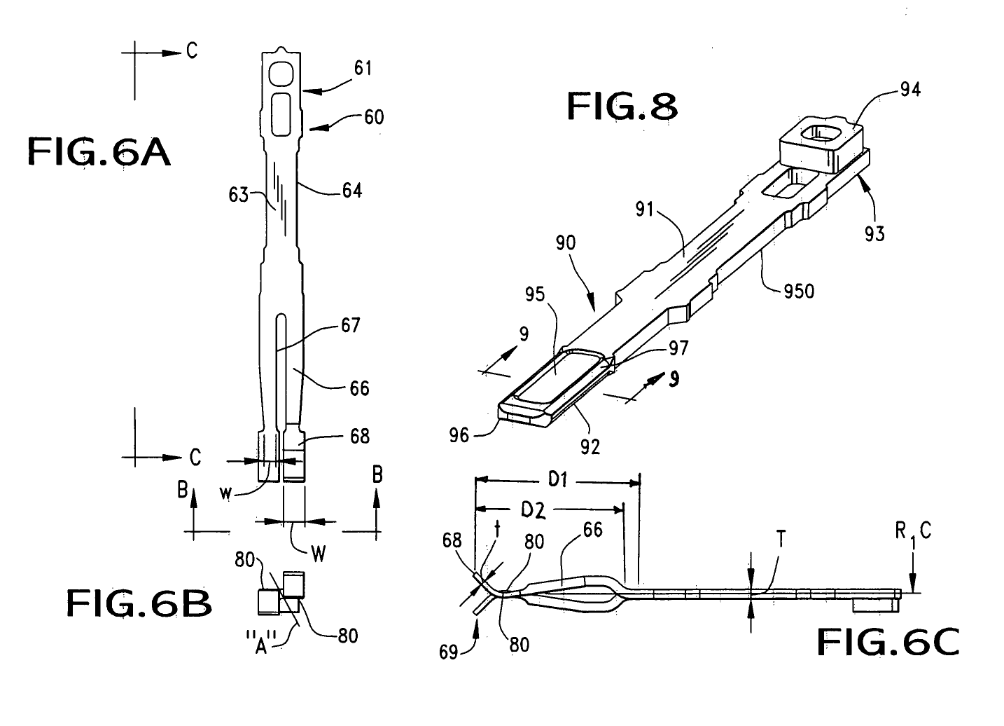

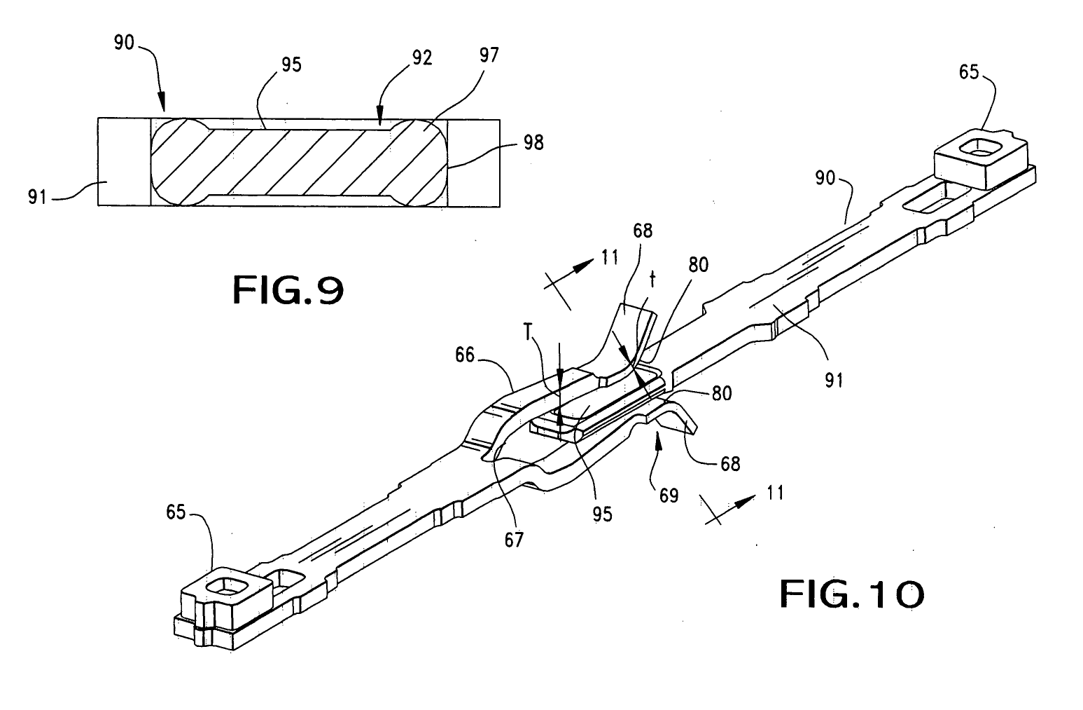

The base shape of the terminal 60 is initially formed by stamping the overall terminal structure from a sheet metal blank (not shown). The slot 67 is stamped to form the pair of arms in the spaced-apart fashion as shown in FIG. 6A. The contact arms 66 have free end portions 69 that preferably include, as shown, enlarged contact faces 68 that are reduced in thickness but are enlarged in overall size. These contact faces have a general rectangular configuration when viewed from above or below (FIG. 6A) but are coined into an arcuate configuration, as best shown in FIG. 6C. The enlarged contact faces 68 are formed by coining the free end portions 69 to a preselected extent that will reduce their thickness from a thickness T in the body portion 63 (FIG. 6C) down to a lesser thickness t and will increase the width of the contact arms at the contact faces from the width w shown in phantom in FIG. 6A to the final coined width W. Preferably, the reduced thickness t is about one-half that of the terminal body portion thickness T.

The contact arms 66 are also formed to include a somewhat arcuate, preferably semi-circular configuration and they are formed in opposite arcuate directions as shown best in FIG. 6C, where it can be seen that one of the contact arms extends above the longitudinal axis R of the body portion and the centerline C of the terminal 60, while the other contact arm extends below these axes. The two contact arms meet, or rejoin the axes, in the area of the contact arm free ends 69 and specifically at the enlarged contact faces 68 thereof. The contact faces are formed into a portion of an arc and the bases 80 (or bottom surfaces) of the contact faces are offset from each other along an angled line A as shown in FIG. 6B so that each such bottom contact surface 80 lies beneath the top or bottom surfaces of the body portion of the terminal 60 when viewed from the contact end. (FIG. 6C.) The terminals are stamped and with stamping, the slot 67 is easier to form and obtain the desired clearance for forming the two contact arms, or beams 66.

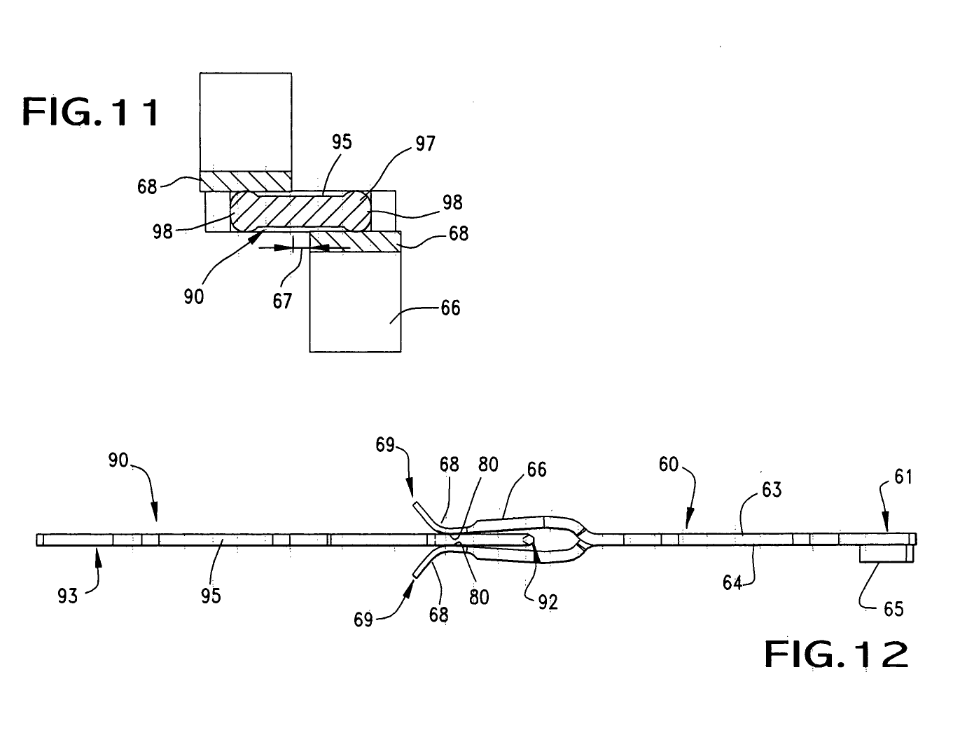

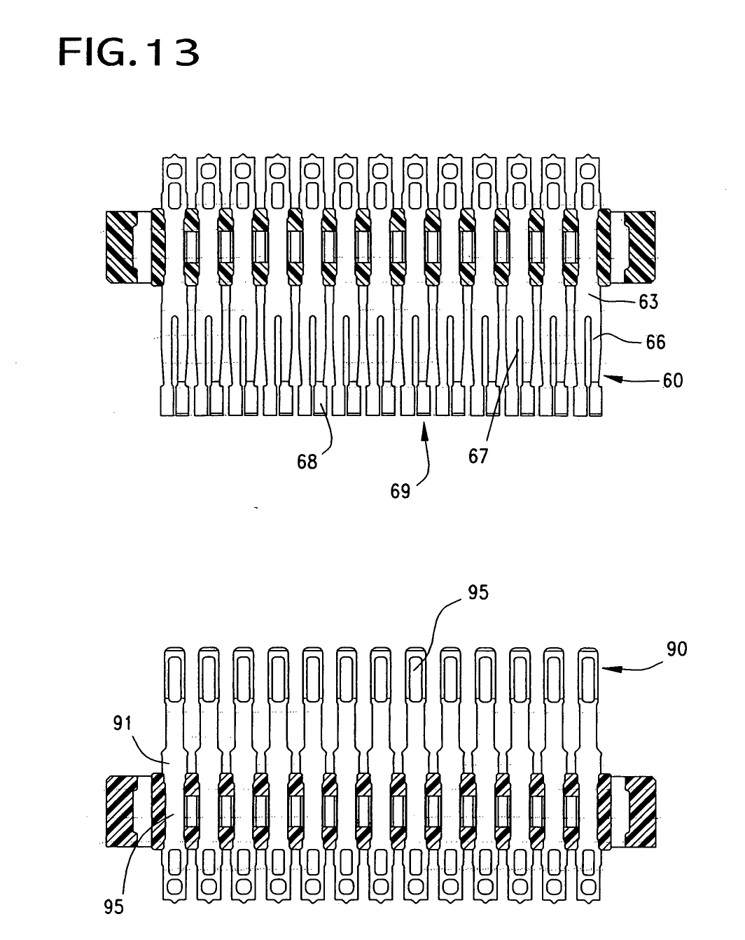

The two contact arms 66 act as a pair of cantilevered beams that extend from the terminal body portions 63 and the structure of the terminals assists in reducing the stress encountered by terminals of the invention during use. As shown in FIG. 5, the slot 67 extends for a first preselected distance D1 from the free ends 69 of the contact arms 66, while the contact arms 66 do not begin their arcuate configuration at the same distance, but rather a second preselected distance D2 that is less than the first distance. This is better shown in FIG. 6C, where it can be seen that the slot 67 begins (or ends) a distance before the contact arms begin to bend up (or down) out of their stamped plane. The difference between the lengths D1 and D2 is the distance which the slot extends back from the initial bending of the contact arms. In this regard, the bending or forming of the contact arms occurs spaced away from the leading edge 82 of the slot 67. In another important aspect of the present invention, the reduced thickness t of the contact faces 69 reduces the stress placed on the cantilevered contact arms. The enlarged widths of the contact faces 69 will flex independently of the contact arms and therefore take into account the variability of the dimensions of the opposing mating blade contacts. The manner of contact between the two terminals is shown best in FIG. 11.

FIG. 8 illustrates a male terminal of the present which is formed as an elongated blade terminal 90 having a body portion 91 that extends between a contact portion 92 and a tail portion 93, the tail portion also being shown with a soldering member 94. The body portion 91 may be provided with notches 950 in its sides for retention purposes in instances where the terminals 90 are molded into a support member 70. FIG. 7 illustrates an array of male terminal 90 that are maintained in alignment within an insulative terminal support member 70, having the openings 76 and end projections 72 as mentioned above.

In order to take advantage of the wide contact faces 68 of the female terminals, the blade terminal 90 is preferably formed with two shallow recesses 95 proximate to the free ends 96 of the contact portions 92. These recesses define two specific side edges 97, which are preferably rolled to form a radius as best shown in FIG. 11 to form cylindrical side edges. The contact faces 68 maintain a point-style contact with these side edges with the contact arms undergoing cantilevered deflection, rather than torsional deflection as is the case with prior art terminals. The cylindrical shape of the side edges need not be exact cylinders, but may include flats 98 on the outboard surfaces of the edges. The presence of the center recess 95 of the blade terminal permits the two contact beam contact surfaces 68 to be slightly out of alignment and still maintain reliable contact with the blade terminal. The blade terminal 90 preferably has a width that is about equal to the center-to-center distance of the contact faces 68 as shown in FIG. 11.

The blade terminals 90 are likewise held in insulative terminal support members 70, each of which fits into the male connector component 52. The terminal support members 70 are preferably hollow with an open central portion 76 that runs widthwise between the two endfaces 73. These central portions 76 will define a series of air pockets 77 between adjacent terminal support members 70.

While the preferred embodiment of the invention have been shown and described, it will be apparent to those skilled in the art that changes and modifications may be made therein without departing from the spirit of the invention, the scope of which is defined by the appended claims.

I claim:

1. A electrical connector system comprising a male connector and a female connector, the two connectors being mateable with each other;
the male connector including at least one male terminal in the form of an elongated blade having a contact portion, a tai portion and a body portion interconnecting the tail and contact portion together;
the female connector including at least one female terminal having a tail portion, a contact portion and a body portion interconnecting the contact and tail portions together, the female terminal including a slot extending lengthwise within the body portion thereof, the slot defining a pair of contact arms, each of the contact arms being formed into an arcuate configuration and the two contact arms extending lengthwise on opposite sides of a longitudinal axis of said female terminal body portion, each of the contact arms further including an enlarged contact surface at a free end thereof, the enlarged contact surface being coined to enlarge it and reduce its thickness to less that a corresponding thickness of said female terminal body portion.

2. The connector system of claim 1, wherein said male terminal includes a depression formed on opposite sides thereof within said contact portion to define longitudinal edges that run lengthwise of said male terminal contact portion, the male terminal edges contacting said contact surfaces of said female terminal, when said male and female connector are mated together.

3. The connector system of claim 2, wherein said male terminal edges are radiused to define an arcuate exterior thereto.

4. The connector system of claim 1, wherein said contact surfaces face in opposite directions.

5. The connector system of claim 1, wherein said female terminal has a Y-shaped configuration when viewed from a side edge.

6. The connector system of claim 1, wherein said female terminal slot has a length greater than a length of any of the female terminal contact arms.

7. The connector system of claim 1, wherein said female terminal contact arms deflect in a cantilevered fashion when mated to said male terminal.

8. The connector system of claim 1, wherein said female terminal is supported by an insulative support, the support having an opening on one side exposing part of said female terminal body portion to air.

9. The connector system of claim 1, wherein said male connector includes a plurality of male terminals arranged in distinct linear arrays, and said female connector includes a plurality of female terminals also arranged in distinct linear arrays.

10. The connector system of claim 9, wherein each of male and female terminal arrays are support within respective insulative terminal supports, each of the terminal supports including a opening disposed along one side of said supports, the opening exposing said male and female terminal body portions to air.

11. A connector, comprising:
a insulative housing, the housing having a base and a mating face, the mating face including a plurality of terminal-receiving cavities disposed therein,
a plurality of terminal supports received in said housing, each of the supports supporting an array of conductive terminals, each of said supports further including means for engaging said housing base to hold said supports in place such that portions of said terminals are received within the terminal-receiving cavities; and,
each of said terminals including a tail end, a contact end and a body interconnecting the tail and ends together, each said terminal further including a lengthwise spacing slot formed in said contact end, the spacing slot defining a pair of contact arms at said contact end, the contact arms being arcuately formed to extend in opposing directions, each of said contact arms further including an enlarged contact surface, the enlarged contact surfaces facing each other.

12. The connector of claim 11, wherein said enlarged contact surfaces are formed by coining said terminal contact ends.

13. The connector of claim 11, wherein said spacing slot has a first length and said contact arms have a second length, the first length being greater than said second length.

14. The connector of claim 11, wherein said spacing slot extends lengthwise into said terminal from said contact end and ends at a first position, and said contact arms are bent outwardly from said terminal body portion, the bends beginning a preselected distance from the first position.

15. The connector of claim 11, wherein said enlarged contact surfaces are wider than corresponding widths of said contact arms.

16. The connector of claim 11, wherein said terminals are arranged in linear arrays within each of said supports.

17. The connector of claim 16, wherein each of said supports have an opening formed therein that exposes one side of said terminal body portions supported thereby to air.
